(19) United States
(12) Patent Application Publication
(10) Pub. No.: US 2019/0347914 A1
(43) Pub. Date: Nov. 14, 2019

(54) INFORMATION PROCESSING APPARATUS, INFORMATION PROCESSING METHOD, AND INFORMATION PROCESSING PROGRAM

(71) Applicant: NEC CORPORATION, Tokyo (JP)

(72) Inventors: Yutaka KINOSHITA, Tokyo (JP); Shunsuke ISHII, Tokyo (JP)

(73) Assignee: NEC CORPORATION, Tokyo (JP)

(21) Appl. No.: 16/469,950

(22) PCT Filed: Nov. 9, 2017
(86) PCT No.: PCT/JP2017/040435

§ 371 Date: Jun. 14, 2019

(30) Foreign Application Priority Data
Dec. 15, 2016 (JP) 2016-243725

(51) Int. Cl. G08B 13/196; G08B 25/00; H04N 7/18

(52) U.S. Cl. CPC G08B 13/196; H04N 7/18; G08B 25/004

(57) ABSTRACT

There is disclosed an information processing apparatus for effectively using information indicating the state of a store visitor at the time of a visit. This information processing apparatus includes a first analyzer that analyzes first video information captured by an outside-the-store camera for capturing an outside of a store to recognize a store visitor at the time of a visit, a second analyzer that analyzes second video information captured by the outside-the-store camera to recognize a situation outside the store after the store visitor visits the store, and a comparator that compares an analysis result of the first analyzer with an analysis result of the second analyzer.

### CROSS REFERENCE TO RELATED APPLICATIONS

This application is based upon and claims the benefit of priority from Japanese patent application No. 2016-243725, filed on Dec. 15, 2016, the disclosure of which is incorporated herein in its entirety by reference.

### TECHNICAL FIELD

The present invention relates to an information processing apparatus, an information processing method, and an information processing program.

### BACKGROUND ART

In the above technical field, patent literature 1 discloses a technique of performing, with a camera, image capturing/video analysis of a license plate of a vehicle entering a parking lot, specifying a customer, and providing an image in accordance with the customer.

### CITATION LIST

### Patent Literature

Patent literature 1: Japanese Patent Laid-Open No. 2016-045949

### SUMMARY OF THE INVENTION

### Technical Problem

In the technique described in the above literature, however, only a license plate is captured to specify a store visitor, and it is impossible to effectively use the state of the store visitor at the time of a visit.

The present invention enables to provide a technique of solving the above-described problem.

### Solution to Problem

One example aspect of the present invention provides an information processing apparatus comprising:

a first analyzer that analyzes video information acquired by capturing an outside of a store to recognize a store visitor at the time of a visit;

a second analyzer that analyzes video information captured by an outside-the-store camera to recognize a situation outside the store after the store visitor visits the store; and

a comparator that compares an analysis result of the first analyzer with an analysis result of the second analyzer.

Another example aspect of the present invention provides an information processing method comprising:

analyzing video information acquired by capturing an outside of a store to recognize a store visitor at the time of a visit;

analyzing video information captured by an outside-the-store camera to recognize a situation outside the store after the store visitor visits the store; and

comparing an analysis result in the analyzing the video information acquired by capturing the outside of the store with an analysis result in the analyzing the video information captured by the outside-the-store camera.

Still other example aspect of the present invention provides an information processing program for causing a computer to execute a method, comprising:

analyzing video information acquired by capturing an outside of a store to recognize a store visitor at the time of a visit;

analyzing video information captured by an outside-the-store camera to recognize a situation outside the store after the store visitor visits the store; and

comparing an analysis result in the analyzing the video information acquired by capturing the outside of the store with an analysis result in the analyzing the video information captured by the outside-the-store camera.

### Advantageous Effects of Invention

According to the present invention, it is possible to effectively use information indicating the state of a store visitor at the time of a visit.

### BRIEF DESCRIPTION OF DRAWINGS

FIG. 1 is a block diagram showing the arrangement of an information processing apparatus according to the first example embodiment of the present invention;

FIG. 2 is a block diagram showing the arrangement of an information processing apparatus according to the second example embodiment of the present invention;

FIG. 3 is a table showing a store visitor database of the information processing apparatus according to the second example embodiment of the present invention;

FIG. 4 is a flowchart illustrating the procedure of processing in the information processing apparatus according to the second example embodiment of the present invention;

FIG. 5 is a view showing the use state of the information processing apparatus according to the second example embodiment of the present invention;

FIG. 6 is a flowchart illustrating the procedure of processing in the information processing apparatus according to the second example embodiment of the present invention;

FIG. 7 is a view showing the use state of the information processing apparatus according to the second example embodiment of the present invention;

FIG. 8 is a flowchart illustrating the procedure of processing in the information processing apparatus according to the second example embodiment of the present invention;

FIG. 9 is a view showing the use state of the information processing apparatus according to the second example embodiment of the present invention;

FIG. 10 is a view showing the use state of the information processing apparatus according to the second example embodiment of the present invention;

FIG. 11 is a view showing the use state of the information processing apparatus according to the second example embodiment of the present invention;

FIG. 12 is a flowchart illustrating the procedure of processing in the information processing apparatus according to the second example embodiment of the present invention;

FIG. 13 is a flowchart illustrating the procedure of processing in the information processing apparatus according to the second example embodiment of the present invention; and

FIG. 14 is a view showing the use state of the information processing apparatus according to the second example embodiment of the present invention.

### DESCRIPTION OF EXAMPLE EMBODIMENTS

Example embodiments of the present invention will now be described in detail with reference to the drawings. It should be noted that the relative arrangement of the components, the numerical expressions and numerical values set forth in these example embodiments do not limit the scope of the present invention unless it is specifically stated otherwise.

### First Example Embodiment

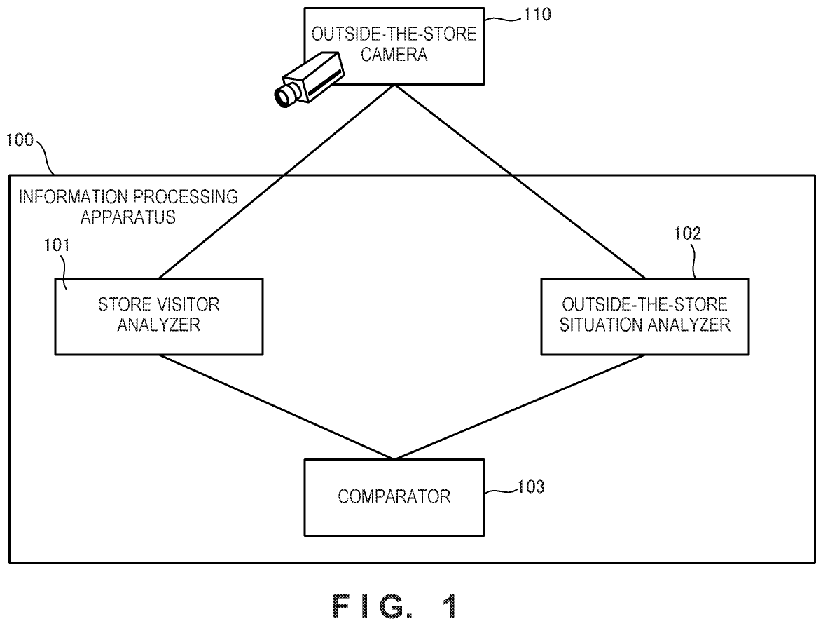

An information processing apparatus 100 according to the first example embodiment of the present invention will be described with reference to FIG. 1. As shown in FIG. 1, the information processing apparatus 100 includes a store visitor analyzer 101, an outside-the-store situation analyzer 102, and a comparator 103.

The store visitor analyzer 101 analyzes video information captured by an outside-the-store camera 110 provided outside a store to recognize a store visitor at the time of a visit.

The outside-the-store situation analyzer 102 analyzes the video information captured by the outside-the-store camera 110 to recognize a situation outside the store after the store visitor visits the store.

The comparator 103 compares an analysis result of the store visitor analyzer 101 with that of the outside-the-store situation analyzer 102.

With the above arrangement, it is possible to effectively use information about a store visitor.

### Second Example Embodiment

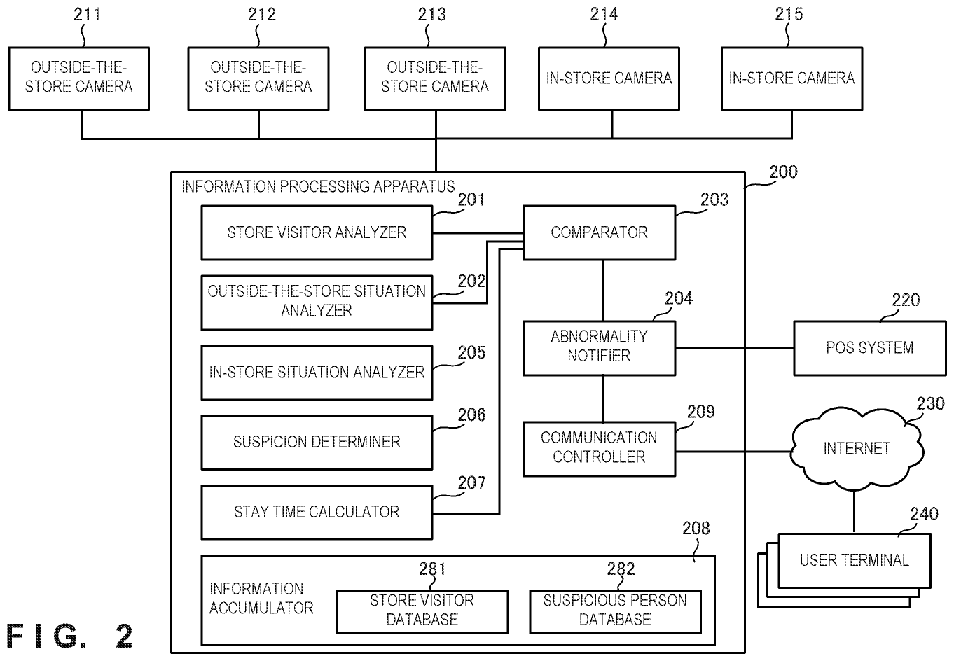

An information processing apparatus 200 according to the second example embodiment of the present invention will be described next with reference to FIG. 2. FIG. 2 is a block diagram for explaining the functional arrangement of the information processing apparatus 200 according to this example embodiment.

The information processing apparatus 200 is an apparatus for receiving videos from outside-the-store cameras 211 to 213 provided outside a store and in-store cameras 214 and 215 provided inside the store, analyzing them, and using an analysis result for the operation of the store. FIG. 2 exemplifies the three outside-the-store cameras and the two in-store cameras. However, the number of outside-the-store cameras and the number of in-store cameras are not limited to them, as a matter of course. The store is not limited to a retail store, and the present invention is applicable to all types of business establishments such as dining and/or dining establishments and amusement facilities.

The information processing apparatus 200 is connected to the Internet 230 and a POS (Point Of Sales) system 220 that manages sales in the store.

The information processing apparatus 200 includes a store visitor analyzer 201, an outside-the-store situation analyzer 202, a comparator 203, an abnormality notifier 204, an in-store situation analyzer 205, a suspicion determiner 206, a stay time calculator 207, an information accumulator 208, and a communication controller 209.

The store visitor analyzer 201 analyzes the videos received from the outside-the-store cameras 211 to 213, performs processes of recording store visit time, recognizing the face of each store visitor, recognizing a store visit means, determining a rank, recognizing an accompanying person, and determining tastes, and stores an analysis result in a store visitor database 281.

The outside-the-store situation analyzer 202 analyzes the videos received from the outside-the-store cameras 211 to 213, and analyzes various situations outside the store. For example, the outside-the-store situation analyzer 202 analyzes a person who has left the store, analyzes a store visit means (transporter) which a store visitor parks outside the store, and analyzes a suspicious person.

The comparator 203 compares the analysis result of the store visitor analyzer 201 with that of the outside-the-store situation analyzer 202.

The abnormality notifier 204 detects an abnormality outside the store based on a comparison result of the comparator 203, and notifies a clerk or the store visitor of the abnormality via the POS system 220 or the Internet 230. The abnormality notifier 204 sends, informs or transmits an abnormality notification message to a mobile information terminal held by the store visitor or the clerk.

The in-store situation analyzer 205 analyzes the videos received from the in-store cameras 214 and 215 to recognizes a situation in the store. The in-store situation analyzer 205 determines, as the situation in the store, a place where each recognized store visitor is, whether there is a store visitor in need, and the like.

The suspicion determiner 206 receives the analysis result in the abnormality notifier 204 or the in-store situation analyzer 205 to determine a suspicious person. Information (image, date/time, behavior, the number of times, and the like) about the determined suspicious person is stored in a suspicious person database 282.

The stay time calculator 207 calculates, for each store visitor, a stay time from when he/she visits the store until he/she leaves the store, and stores it in the store visitor database 281. By calculating the store stay time of each store visitor, it is possible to determine a time period during which a limited-time offer should be presented, and specify targets of vouchers or discount sales promotion, and transmission destinations of direct mail. For example, it is considered that vouchers or discount sales promotion is effective for a person who makes a long stay since he/she intentionally buys only a few items, and that it is effective to send in advance direct mail to a person who makes a short stay since he/she intentionally buys many items.

The information accumulator 208 accumulates various data such as the store visitor database 281 and the suspicious person database 282.

The communication controller 209 communicates, via the Internet 230, with a user terminal 240 of a user who has performed member registration.

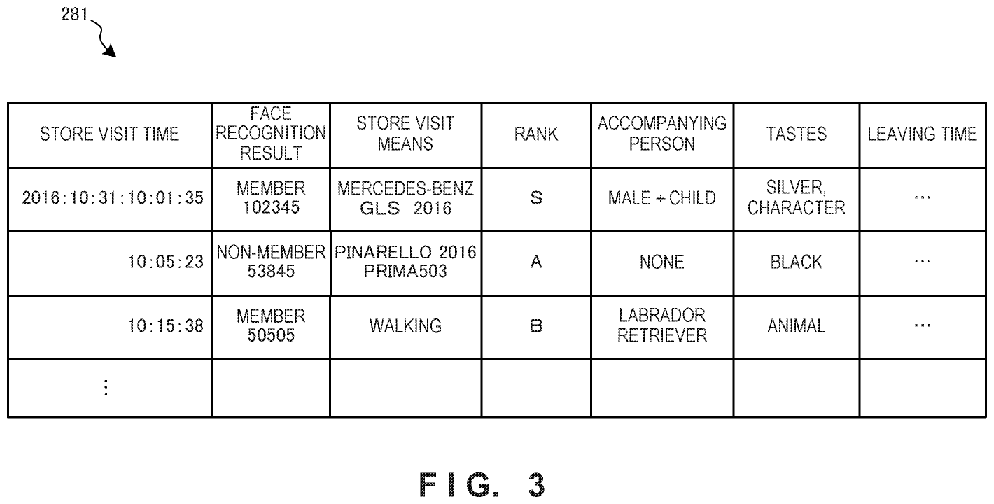

FIG. 3 shows store visitor data as the analysis result of the store visitor analyzer 201. For each store visitor, if it is determined as a result of face recognition that the store visitor matches a person registered in advance as a member of the store, a member number is recorded in addition to store visit time and leaving time. If it is determined that the store visitor does not match any person registered in advance as a member of the store, the store visitor is assigned with a new number as a non-member.

Alternatively, if there is a non-member database in which non-member data is registered, an ID as a non-member is registered in the store visitor database 281 with reference to the non-member database. This makes it possible to determine how often the store visitor visits the store even if he/she is a non-member.

Furthermore, a store visit means for each store visitor is registered in the store visitor database 281. As for the store visit means, a transporter such as walking, a car, a bicycle, a motorcycle (motorbike), a taxi, a fixed-route bus, or a train is registered as much detailed information as possible. For the car, a vehicle type and model year are specified based on the vehicle shape and emblem with reference to various vehicle databases, and then registered.

In addition, a rank is determined based on the number of visits, the purchase history, the price of the store visit means, and the like of each store visitor, and is registered in the store visitor database 281.

The store visitor database 281 further stores an accompanying person of each store visitor. If people look like a family, the presence/absence of an accompanying person such as a male accompanying person and a child other than a female as a store visitor (member) is registered. An accompanying person database may be additionally prepared to store data such as the face, clothing, and age of an accompanying person. As for a store visitor with a dog, the kind of the dog may be determined and registered.

Furthermore, the tastes of each store visitor are registered in the store visitor database 281. The tastes of each store visitor such as a favorite color, a favorite character, and a hobby (golf, fishing, or the like) are determined, recognized, and registered.

Any data such as a direction from which each store visitor visits the store, which is obtained by analyzing the videos of the outside-the-store cameras, may be registered in the store visitor database 281 in addition to the above data. Moreover, an additionally prepared member database (not shown) may be updated using the contents registered in the store visitor database 281.

[Procedure of Lost Person or Kidnapping Discovery Processing]

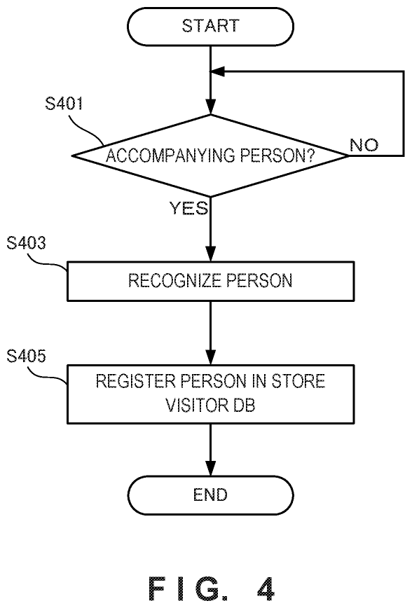

The procedure of lost person or kidnapping discovery processing performed in the information processing apparatus 200 will be described with reference to FIGS. 4 to 7.

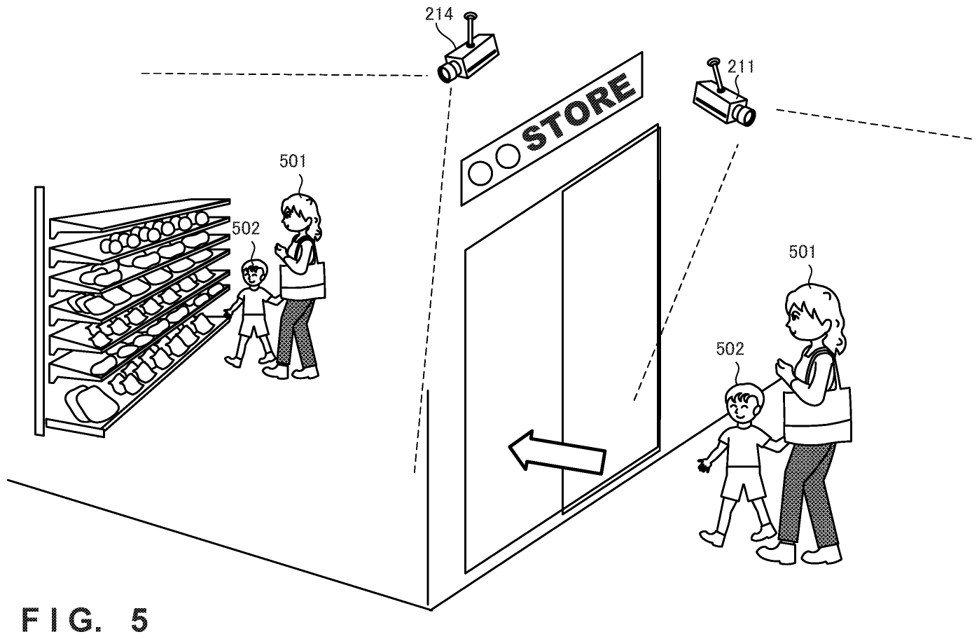

FIG. 4 is a flowchart illustrating the procedure of processing of registering an accompanying person. FIG. 5 is a view showing an example of a situation in which a store visitor with an accompanying person visits the store. In step S401, the store visitor analyzer 201 determines whether a store visitor 501 is with an accompanying person. If an accompanying person 502 is found, the process advances to step S403 to recognize the person (face, physique, and clothing). In step S405, a recognition result is registered in the store visitor database 281. That is, a specific accompanying person who visits the store with a specific store visitor is determined and registered.

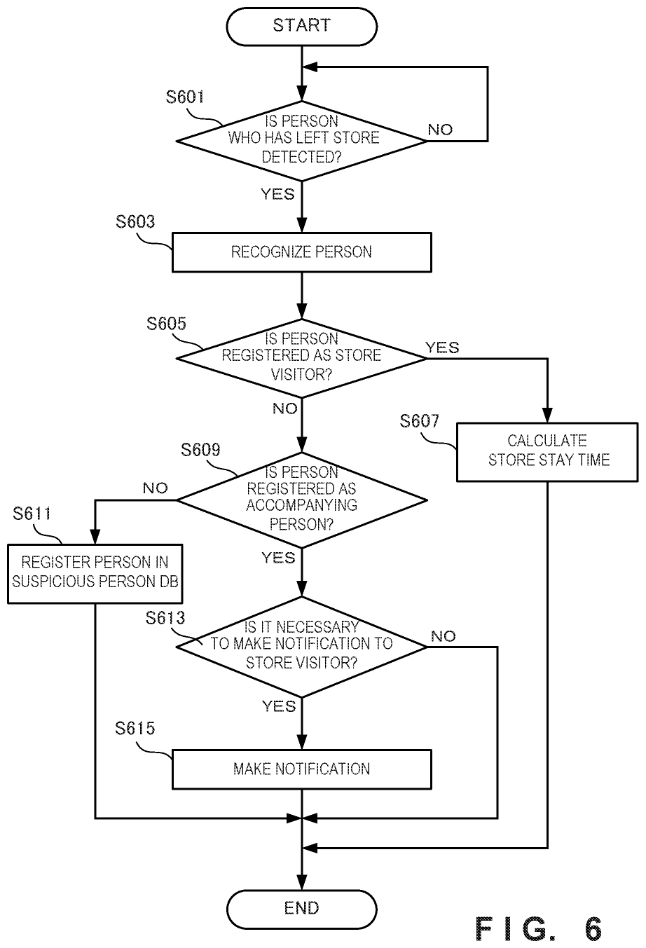

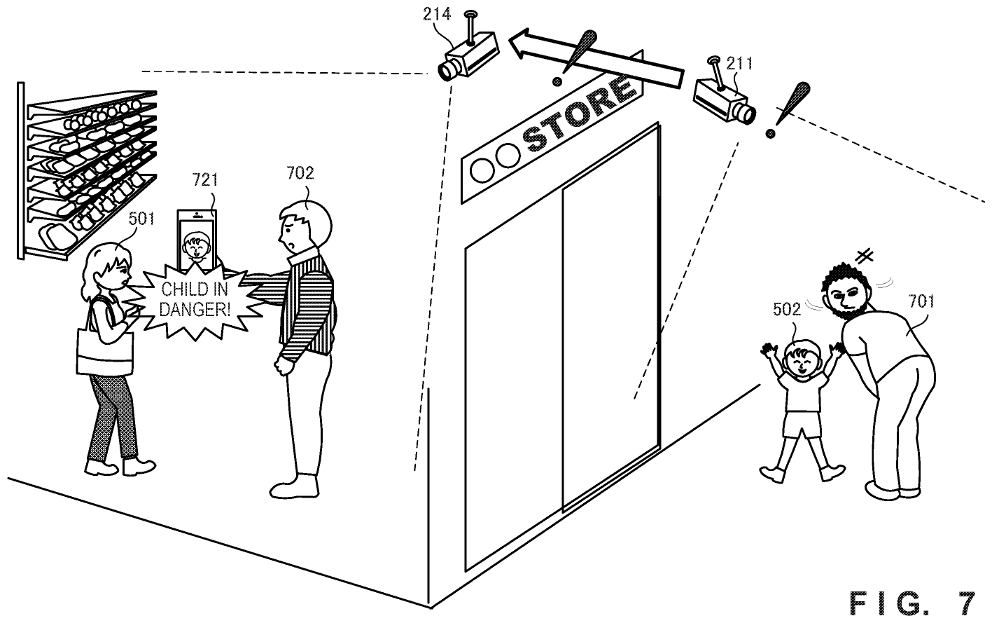

FIG. 6 is a flowchart illustrating the procedure of processing of checking a person who has left the store. FIG. 7 is a view showing an example of a situation in which an accompanying person has left the store. In step S601, if a person who has left the store is detected, person recognition processing is performed in step S603, and it is determined in step S605 whether the person is registered as a store visitor in the store visitor database 281.

If it is determined that a person who is registered as a store visitor has left the store, the process advances to step S607, and a store stay time is calculated and registered in the store visitor database 281 and the member database.

If it is determined in step S605 that the person is not registered as a store visitor in the store visitor database 281, it is determined in step S609 whether the person is registered as an accompanying person. If the person is not registered as either a store visitor or an accompanying person, the process advances to step S611, and the person is register as a suspicious person in the suspicious person database 282.

If it is determined in step S609 that the person who is registered as an accompanying person has left the store, the process advances to step S613, and it is determined whether it is necessary to notify the store visitor of it by determining whether the store visitor accompanying the person at the time of the visit is nearby. If, as shown in FIG. 7, the very young accompanying person 502 has left the store and the store visitor 501 is not nearby (for example, within a radius of 5 m), the abnormality notifier 204 transmits, in step S615, a notification message as an abnormality to a terminal 721 of a clerk 702. At this time, by making it possible to display a photograph of the face of the store visitor 501 to which a notification is to be made, the clerk 702 readily discovers the store visitor 501. At the same time, the suspicion determiner 206 determines whether a suspicious person exists near the accompanying person 502. If a suspicious person 701 exists, an image of the suspicious person 701 and the like are registered in the suspicious person database 282.

With this processing, it is possible to quickly discover a child or an old person who accompanied a store visitor and has got lost or has been kidnapped, and notifies the store visitor of it, thereby preventing a trouble.

[Procedure of Outside-the-Store Theft Discovery Processing]

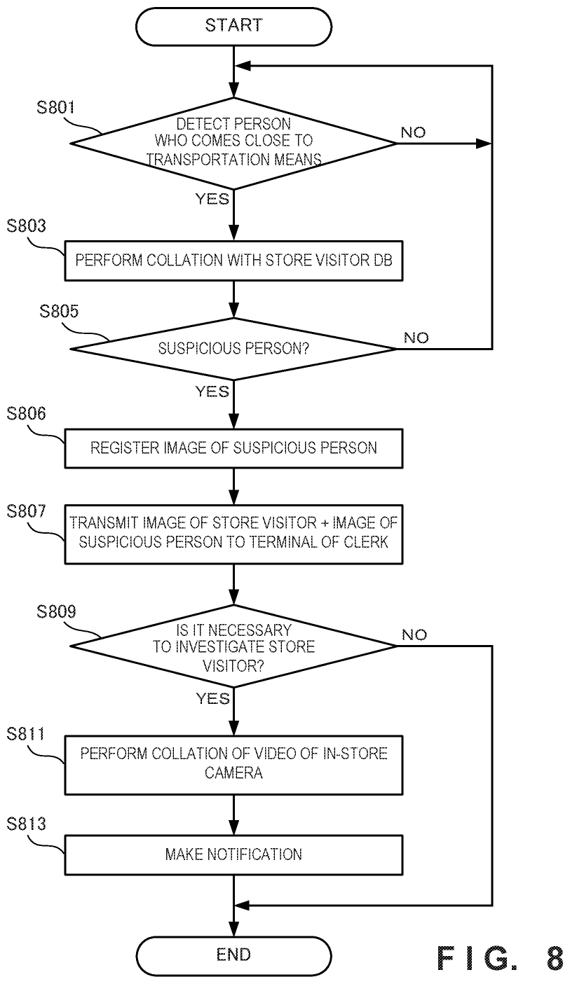

The procedure of outside-the-store theft discovery processing performed in the information processing apparatus 200 will be described with reference to FIGS. 8 to 11.

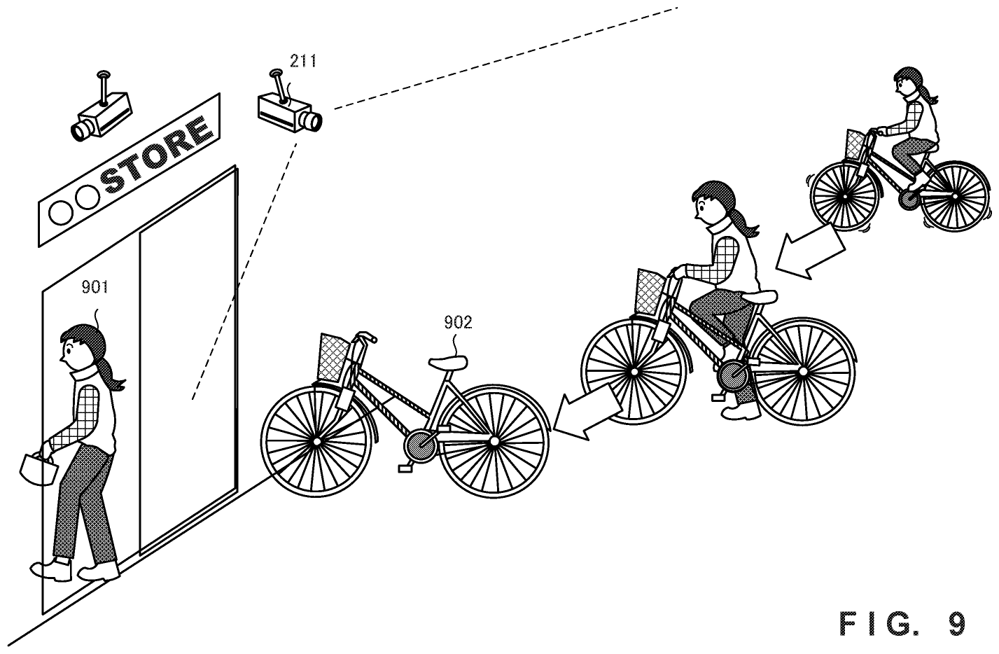

FIG. 8 is a flowchart illustrating the procedure of processing of making an outside-the-store theft notification. Assume that, as shown in FIG. 9, a transporter (a bicycle 902 in FIG. 9) used by a store visitor 901 is recognized and associated with store visitor information, and an image, type, position, and the like of the transporter are registered in the store visitor database 281.

After that, in step S801, the outside-the-store situation analyzer 202 analyzes videos captured by the outside-the-store cameras 211 to 213. If a person who contacts the transporter is detected, the process advances to step S803. In step S803, the comparator 203 performs collation with the store visitor database 281 to determine whether the person who contacts the transporter is registered as a store visitor or an accompanying person.

The process advances to step S805. If the suspicion determiner 206 recognizes that the person who comes close to the bicycle 902 is a suspicious person 1001 different from the store visitor 901, as shown in

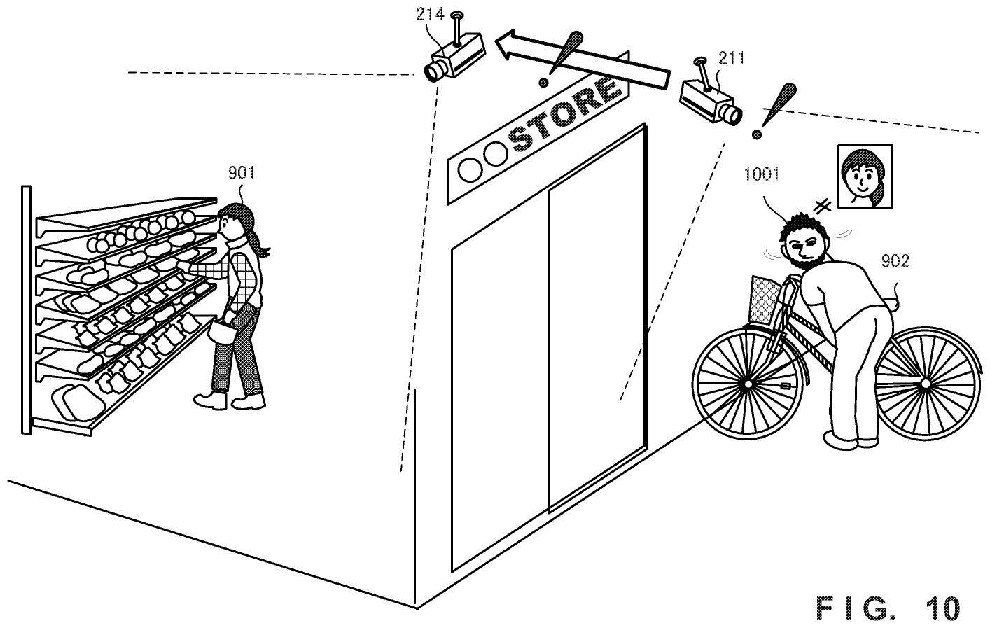

FIG. 10, an image of the suspicious person is registered in the suspicious person database 282 in step S806.

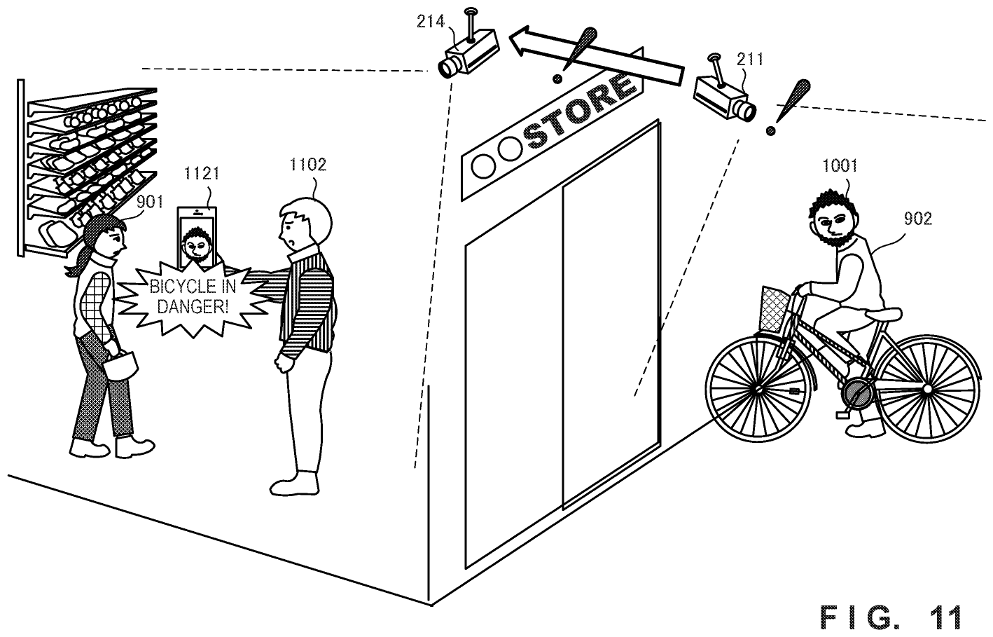

The process advances to step S807, an image of the suspicious person 1001 and an image of the store visitor 901 are transmitted to a terminal 1121 of a clerk 1102, as shown in FIG. 11. If it is difficult for the clerk 1102 to find the store visitor 901, the process advances from step S809 to step 811, and the in-store situation analyzer 205 analyzes a video of the in-store camera 214. Based on an analysis result of the in-store situation analyzer 205, the abnormality notifier 204 notifies the terminal 1121 of the clerk 1102 of the position of the store visitor 901 (step S813).

With this processing, it is possible to quickly discover a wrong action for the transporter of a store visitor, and notify the store visitor of it. The bicycle has been exemplified as the transporter. However, the present invention is applicable to discovery or exposure of a car theft of a car, as a matter of course.

[Procedure of Shoplifting Exposure Processing]

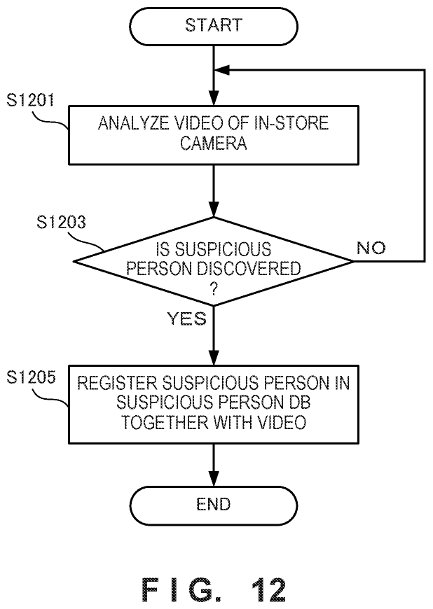

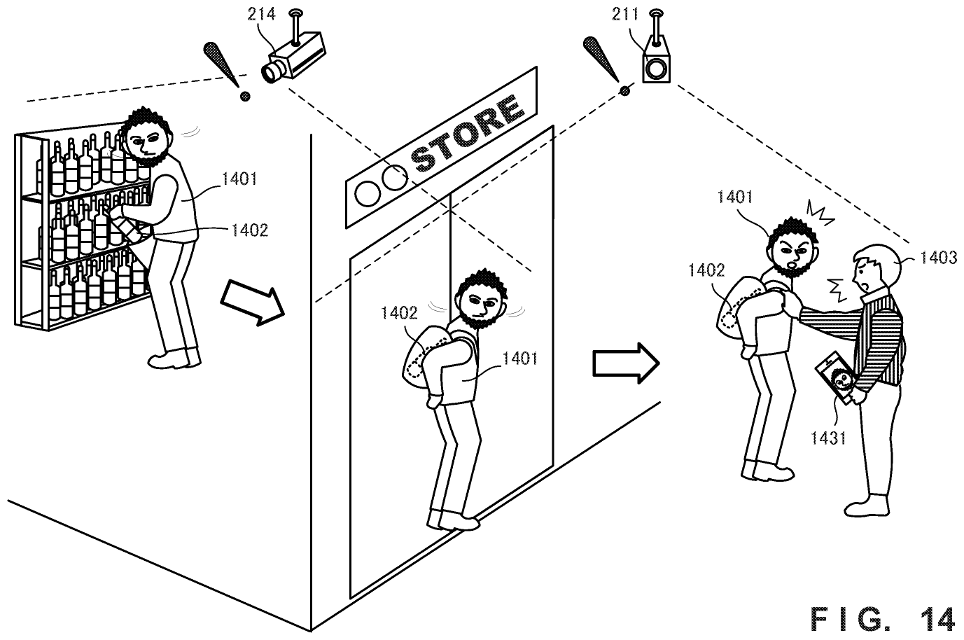

The processing of practical processing performed in the information processing apparatus 200 will be described with reference to FIGS. 12 to 14. Referring to FIG. 12, in step S1201, the in-store situation analyzer 205 analyzes a video of the in-store camera 214 or the like. If a suspicious person is discovered, in step S1203, as a result of analyzing the video, the process advances to step S1205, and the suspicious person is registered in the suspicious person database 282 together with the video. For example, as shown in FIG. 14, if a suspicious person 1401 who may have shoplifted is discovered from the video of the in-store camera 214, a face image of the suspicious person, information of a product 1402, and the like are registered in the suspicious person database 282.

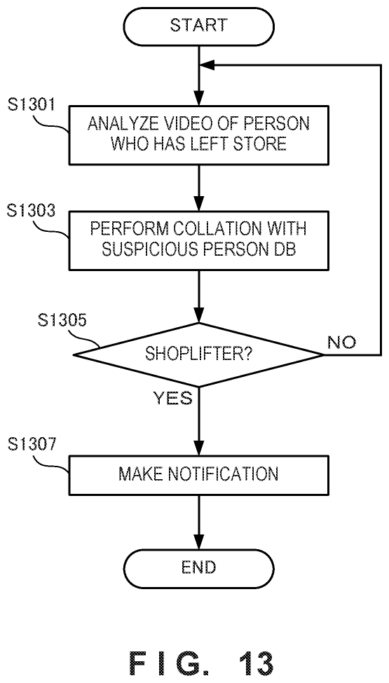

Referring to FIG. 13, in step S1301, the outside-the-store situation analyzer 202 analyzes a video captured by the outside-the-store camera 211 to extract a person image of a person who has left the store. In step S1303, the person image is collated with the suspicious person database 282. In step S1305, it is determined whether the person registered, in the suspicious person database 282, as a suspicious person who may have shoplifted has left the store. If such the suspicious person 1401 has left the store, the process advances to step S1307, and a terminal 1431 (the terminal of a guard may be possible, as a matter of course) of a clerk 1403 is notified of it. Whether such suspicious person has paid may be confirmed by a video of the in-store camera, as a matter of course.

With this processing, whether a suspicious person has shoplifted can be confirmed only after he/she has left the store, and the clerk can quickly be notified of the suspicious person who has left the store.

Note that in the above-described example embodiment, for the sake of descriptive convenience, the arrangement in which the outside-the-store situation analyzer 202 analyzes a video captured by the outside-the-store camera 211 to extract a person image of a person who has left the store has been described as an example. This example embodiment has exemplified the arrangement of notifying the terminal 1431 of the clerk 1403 of a determination result. However, the example embodiment of the present invention is not limited to the arrangement. The outside-the-store situation analyzer 202 may adopt an arrangement of analyzing a video captured by the outside-the-store camera 211 to extract a person image and the behavior of a person who has left the store.

An arrangement of notifying a terminal held by the clerk 1403 or the like of information specified based on an extraction result may be adopted. In this case, in this example embodiment, information obtained by associating information representing the behavior of the person who has left the store with information to be notified is held in advance in the information accumulator 208.

Therefore, in this example embodiment, it is possible to obtain the information to be notified, by searching the information accumulator 208 based on the information representing the extracted behavior. As a result, for example, if the person who has left the store eats and drinks, in a car, something bought in the store, the information processing apparatus 200 can notify the clerk, the manager of the store, or the like of information about a store arrangement such as provision of an eating space in the store as the information to be notified. Alternatively, the information processing apparatus 200 can make a notification of information about an assortment or sales promotion in the store.

### Other Example Embodiments

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims.

The present invention is applicable to a system including a plurality of devices or a single apparatus. The present invention is also applicable even when an information processing program for implementing the functions of example embodiments is supplied to the system or apparatus directly or from a remote site. Hence, the present invention also incorporates the program installed in a computer to implement the functions of the present invention by the computer, a medium storing the program, and a WWW (World Wide Web) server that causes a user to download the program. Especially, the present invention incorporates at least a non-transitory computer readable medium storing a program that causes a computer to execute processing steps included in the above-described example embodiments.

1. An information processing apparatus comprising:
at least one memory configured to store instructions; and
at least one processor configured to execute the instructions to;
analyze first video information acquired by capturing an outside of a store to recognize a store visitor at the time of a visit;
analyze second video information captured by an outside-the-store camera to recognize a situation outside the store after the store visitor visits the store; and
compare an analysis result of the first video information with an analysis result of the second video information.

2. The information processing apparatus according to claim 1, wherein the processor is configured to further execute to notify at least one of the store visitor and a clerk of the store of an abnormality based on a result of the comparison.

3. The information processing apparatus according to claim 2, wherein the processor is configured to further execute to transmit an abnormality notification message to at least one of mobile information terminals held by the store visitor and the clerk.

4. The information processing apparatus according to claim 2, wherein the processor is configured to further execute to;
recognize an accompanying person of the store visitor;
detect the accompanying person has left the store without accompanying the store visitor; and
make a notification to one of the store visitor and the clerk.

5. The information processing apparatus according to claim 2, wherein the processor is configured to further execute to:
specify, as a transporter used when the store visitor visits the store, at least one of walking, a car, a bicycle, a motorcycle, a taxi, a fixed-route bus, and a train,
analyze the transporter in the second video information;
detect contact with the transporter by a suspicious person; and
makes notification to one of the store visitor and the clerk while the store visitor is in the store.

6. The information processing apparatus according to claim 2, wherein the processor is configured to further execute to;
analyze third video information indicating a situation inside the store captured by an in-store camera while the store visitor visits the store;
determines, based on an analysis result of said third video information, whether the store visitor has performed a suspicious behavior in the store, and
make a notification to the clerk, in the case where detecting, based on the analysis result of said second video information, that the store visitor performed the suspicious behavior left the store.

7. The information processing apparatus according to claim 1, wherein the processor is configured to further execute to calculate a store stay time of the visitor by comparing store visit time of the recognized store visitor with leaving time of the recognized store visitor.

8. An information processing method comprising:
analyzing first video information acquired by capturing an outside of a store to recognize a store visitor at the time of a visit;
analyzing second video information captured by an outside-the-store camera to recognize a situation outside the store after the store visitor visits the store; and
comparing an analysis result of the first video information with an analysis result of the second video information.

9. A non-transitory computer readable medium storing an information processing program for causing a computer to execute a method, comprising:
analyzing first video information acquired by capturing an outside of a store to recognize a store visitor at the time of a visit;
analyzing second video information captured by an outside-the-store camera to recognize a situation outside the store after the store visitor visits the store; and
comparing an analysis result of the first video information with an analysis result of the second video information.
